(19) United States
(12) Patent Application Publication
(10) Pub. No.: US 2016/0132954 A1
(43) Pub. Date: May 12, 2016

(54) Recommender System Employing Subjective Properties

(71) Applicants: Christian Guckelsberger, Mainz (DE); Florian Probst, Darmstadt (DE); Axel Schulz, Bensheim (DE)

(72) Inventors: Christian Guckelsberger, Mainz (DE); Florian Probst, Darmstadt (DE); Axel Schulz, Bensheim (DE)

(21) Appl. No.: 14/538,315

(22) Filed: Nov. 11, 2014

(51) Int. Cl. G06Q 30/06; G06Q 30/02

(52) U.S. Cl. CPC G06Q 30/0631; G06Q 30/0278

(57) ABSTRACT

Example systems and methods of recommending an item are presented. In one example, preference values for items by multiple users, as well as property values for multiple properties of the items by the users, are accessed. Reference property values for the properties of the items are generated based on the property values. Average deviations from the reference property values for the properties across a first group of the items by a target user are generated. Expected property values for the properties of a second group of the items for the target user are generated based on the reference property values and the average deviations. Preference values of the target user for the second group of the items are estimated based on the expected property values. At least one of the second group of the items is recommended to the target user based on the estimated preference values.

### BACKGROUND

Generally, recommender systems are computer-based systems that may recommend one or more products or other items to users of the systems based on one or more types of available data. More specifically, in at least some examples, a recommender system may extrapolate, from user preferences for items known to the user, possible user preferences for items that are currently unknown to the user. The items being recommended may include, but are not limited to, products and/or services for sale and/or lease (e.g., automobiles, electronic products, movies, television programs, music, books, life insurance, health insurance, vacation and cultural destinations, hotel rooms, airline tickets, and many others), providers of products and/or services (e.g., financial services providers, insurance providers, medical services providers, restaurants, bars, cafés, political parties, and so on), other people (e.g., users of an online dating service), and so forth. The available data upon which the recommendations may be based may include, but are not limited to, data describing user preferences for particular items or types of items, data describing one or more objective aspects (e.g., size, color, cost, and so on) of various items, objective purchase and/or lease data regarding the items (e.g., price, leasing terms, etc.), and so on. Typically, a supplier or distributor of such items or products may employ a recommender system to increase sales, thus potentially increasing revenue and profit.

Many current recommender systems are often described as performing collaborative filtering or content-based filtering as a recommendation technique. A recommender system that employs collaborative filtering may recommend items currently unknown to a target user that are, or have been, preferred by other users that possess similar stated preferences to that of the target user. A recommender system that uses content-based filtering may utilize information that objectively describes the items to recommend products that are currently unknown to the target user but are similar to other items in which the target user has previously expressed an interest. Some recommender systems may represent hybrid systems that employ aspects of both collaborative filtering and content-based filtering to compensate for weaknesses in systems that employ only collaborative or content-based filtering.

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating an example recommender system;

FIG. 2 is a flow diagram illustrating a first example method of recommending an item;

FIG. 3 is a flow diagram illustrating a second example method of recommending an item;

FIG. 4 is a flow diagram illustrating a third example method of recommending an item;

FIG. 5 is a graph of an example distribution of property values for an item as specified by or for a plurality of users;

FIG. 6 is a pseudocode listing for an example function that may recommend, to a target user, items that are unknown to the target user;

FIG. 7 is a graph of an example distribution of items, both known and unknown to a target user, according to stated and estimated property values of the target user;

FIG. 8 is a pseudocode listing for an example function that may determine the most similar known items for each unknown item to a target user, and return estimated preferences associated with the target user for the unknown items;

FIG. 9 is a graphical representation of a range of possible property values for a particular property, indicating lower and upper expectedness boundaries;

FIG. 10 is a pseudocode listing for an example function that may estimate unexpectedness values for each of a set of items that are unknown to a target user; and

FIG. 11 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that exemplify illustrative embodiments. In the following description, for purposes of explanation, numerous specific details are set forth to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

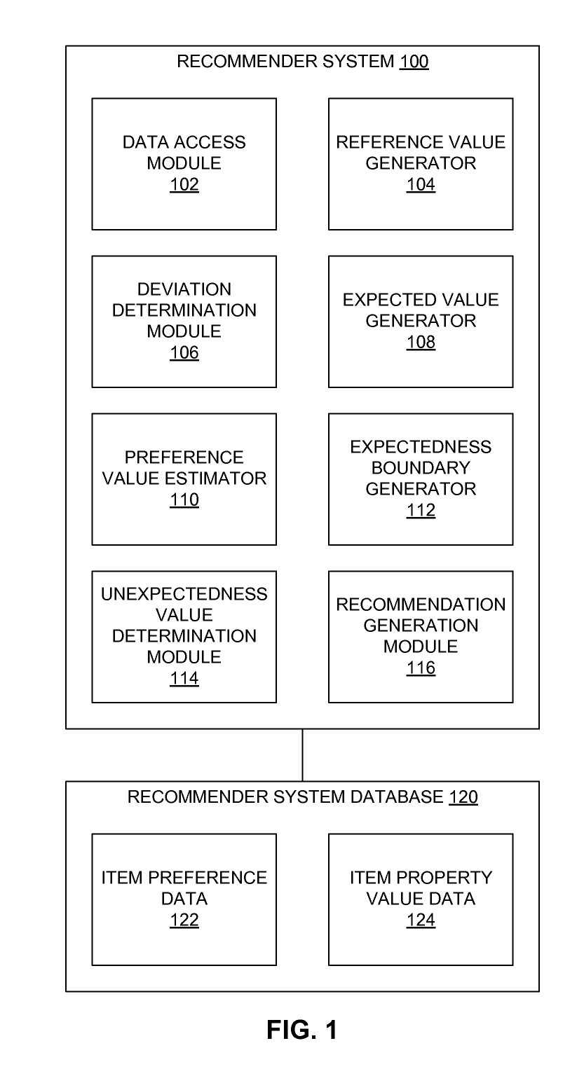

FIG. 1 is a block diagram of an example recommender system 100 configured to recommend one or more items to one or more target users. In at least some examples of the recommender system 100 described in greater detail below, the recommender system 100 may employ preferences specified by a target user and others for a variety of items, as well as values for one or more properties of the items as perceived by those users, to determine which items that are currently unknown to the target user are most likely to be preferred by the target user. Thus, unlike typical content-based filtering systems, the users, as opposed to personnel associated with a content-based filtering system, may supply much of the information describing the various items, thus relieving the provider of the recommender system 100 from supplying that information. More specifically, the provider may specify the particular properties or qualities associated with each item type (e.g., sweetness, color, clarity, and so forth for wine; food quality, level of attentiveness, and so on for a restaurant), while each user of a particular item may then specify a property value representing his or her perception of each property for each item known to that user (e.g., very sweet, moderate clarity, and so on). Additionally, the properties employed by the recommender system 100 may be primarily subjective in nature, thus facilitating the recommendation of items that are largely perceived subjectively by the user.

In some examples described more fully below, the recommender system 100 may also use this same preference and property value information to determine or predict some level of “unexpectedness” for each item that is unknown to a particular target user. This unexpectedness may be based at least in part on a level of deviation of the perception by the target user of the various properties from average or expected property values provided by the users. In some cases, greater levels of deviation toward the extreme low or high end of possible property values may indicate a greater level of inexperience of the user with that type of item, thus possibly rendering recommendations of those particular items at least somewhat unexpected by the user. As shown in the FIG. 1, the recommender system 100 may include a data access module 102, a reference value generator 104, a deviation determination module 106, an expected value generator 108, a preference value estimator 110, an expectedness boundary generator 112, an unexpectedness value determination module 114, and a recommendation generation module 116. Other modules or components of the recommender system 100 not shown in FIG. 1, such as, for example, a display, a user interface, one or more hardware processors, and the like, may be included in the recommender system 100, but are not explicitly shown to focus and simplify the following discussion. Also, each of the modules 102-116 of FIG. 1 may be implemented in hardware, software, or some combination thereof. In some examples, any of the modules 102-116 may be combined with other modules, or may be separated into a greater number of modules.

Also as depicted in FIG. 1, the recommender system 100 may be coupled with a recommender system database 120, which may include item preference data 122 and item property value data 124, as well as any other data employed or generated by the recommendation system, such as, for example, expected property values, deviations, and so on, as described in greater detail below. In some examples, the recommender system database 120 may be incorporated within the recommender system 100, or may be accessible to the recommender system 100 by way of a local area network (LAN) (e.g., Ethernet or WiFi®), wide area network (WAN) (e.g., the Internet), cellular network (e.g., third generation (3G) or fourth generation (4G) network) or other communication system or network.

As is described in greater detail below, the recommender system 100 may be configured to generate recommendations to a target user for items that are unknown to the target user. The items may include any product, service, or other identifiable entity capable of being purchased, leased, or otherwise selected or obtained by the target user. Examples of the items may include, but are not limited to, products and/or services for sale and/or lease (e.g., automobiles, electronic products, movies, television programs, music, books, life insurance, health insurance, vacation and cultural destinations, hotel rooms, airline tickets, and many others), providers of products and/or services (e.g., financial services providers, insurance providers, medical services providers, and so on), other users (e.g., users of an online dating service), and so forth.

As employed herein, an item that is “unknown” to a target user is an item for which the target user has not indicated a particular preference for the item and has not provided property values for one or more properties associated with the item. Conversely, an item is “known” to the target user if the target user has expressed some preference value or level for the item and has provided property values for the one or more item properties.

Also as utilized herein, a “property” for an item is a subjective property or quality associated with the item that a user familiar with the item may perceive and/or evaluate and specify. Using a bottle of wine as an example, possible properties may include, but are not limited to, sweetness, richness, fruitiness, brilliance, hue, and so forth. In various embodiments, the particular properties associated with one type of item (e.g., wine) may be at least partially, and often significantly, different from properties associated with another type of item (e.g., coffee). Thus, a “property value” specified by a user may be some numerical or other type of value that indicates a level, degree, intensity, or strength that the user believes the item possesses regarding that particular property or quality. For example, a user (or someone on behalf of the user) may indicate the value of a particular quality possessed by an item by way of a number on a scale that indicates a relative level of the property, as perceived by the user (e.g., a number from one to ten, with one indicating a low level of the property, and ten indicating a high level of the property). In other examples, the value of a property may be specified by way of a location in a two-dimensional or three-dimensional space, a location along a closed circle or other geometric shape, or via any other means of specifying a particular value for a property among a number or continuum of possible values for the property.

A “preference value” specified by or on behalf of a user for a particular item may be a number, value, or other indication by which the user indicates an overall preference for the item. Such indications may be binary (e.g., “yes” or “no”, “like” or “dislike”, “recommend” or “do not recommend”, and so on), numerical (e.g., on a scale from one to ten, with one indicating “do not prefer” and ten indicating “highly prefer”), iconic (e.g., a selection of a number of “stars,” “tomatoes,” and so on) or the like. Other ways for a user to specify property values and/or preferences may be utilized in other embodiments.

Returning to FIG. 1, the data access module 102 may be configured to access the various preference values (e.g., item preference data 122) and property values associated with items (e.g., item property value data 124) of one or more item types for use by other modules within the recommender system 100 to generate recommendations for one or more items to target users. In some examples, the users may have specified the preference value and property value information for a particular item in response to a survey presented to the user by a provider of the recommender system 100, or by another entity. Such a survey may be provided at some point in time after the user has obtained the item in question. For some types of items (e.g., food, wine, music, films, artwork, etc.), the survey may be provided immediately after the user has obtained the item to help prevent that perception from being altered by experiences with other items. For other types of items (e.g., automobiles, computer equipment, etc.), the survey may be provided after some period of time has elapsed after the user has obtained the item to allow for a more accurate evaluation of certain properties, such as reliability, durability, and the like. Other methods or processes for obtaining the preference value and property value information from the users may be utilized in other embodiments.

The reference value generator 104 may be configured to generate a reference property value for each property of each item of one or more types of items based on the property values specified for the items by the users. In at least some examples, a reference property value represents a consensus value assigned by a plurality of the users to a particular property of an item. As described more fully below, the reference property value may be an average, mean, median, mode, and/or other value in at least some embodiments.

The deviation determination module 106 may be configured to determine a level, magnitude, and/or direction of a deviation between a property value for one or more items known to a target user, as provided by or on behalf of a target user, relative to a corresponding reference property value generated by the reference value generator 104. Further, the deviation determination module 106 may average or otherwise combine multiple such deviations covering multiple items of an item type to generate an average deviation for the target user for each property associated with the item type.

The expected value generator 108 may be configured to generate, determine, or predict expected property values associated with the target user for items that are currently unknown to the target user. These expected property values may be based on the reference property values generated by the reference value generator 104 that are based on property values specified by other users for the unknown items, as well as on the average deviations determined by the deviation determination module 106.

The preference value estimator 110 may be configured to estimate preference values on behalf of the target user for items that are currently unknown to the target user. In some examples, the preference value estimator 110 may estimate the preference values based on the expected property values generated by the expected value generator 108. More specifically, in some embodiments, as described more fully below, the preference value estimator 110 may use the expected property values for an unknown item to select similar items known to the target user and employ the target user's preference values of those known items to estimate a preference value for the unknown item. The resulting preference values for the unknown items may then be forwarded to the recommendation generation module 116, described below, to generate recommendations to the target user.

Some examples of the recommender system 100 may employ the expectedness boundary generator 112 and the unexpectedness value determination module 114 to generate unexpectedness values that the recommendation generation module 116 may combine with the estimated preference values from the preference value estimator 110 to generate the desired recommendations to the target user. For example, the expectedness boundary generator 112 may be configured to generate expectedness boundaries for property values of each property for one or more items that are unknown to the target user. More specifically, each of the expectedness boundaries for a particular property is a boundary beyond which property values specified by a user would be unexpected, thus possibly indicating a level of inexperience of the user with respect to the particular property. The expectedness boundary generator 112 may base these boundaries on the average deviations determined by the deviation determination module 106, and possibly on the reference property values from the reference value generator 104.

The unexpectedness value determination module 114 may be configured to determine the unexpectedness values for each property for an item unknown to a target user based on the expectedness boundaries from the expected boundary generator 112, as well as the expected property value predicted for the target user for the unknown item from the expected value generator 108. Further, the unexpectedness value determination module 114 may be configured to combine the unexpectedness values for each property of an unknown item to produce a combined or overall unexpectedness value for the item relative to the target user.

The recommendation generation module 116 may be configured to recommend one or more items currently unknown to the target user based on the estimated preference values from the preference value estimator 110, and possibly on the overall unexpectedness value for each unknown item, as determined by the unexpectedness value determination module 114. In some embodiments, the recommendation generation module 116 may also base the recommendation on results from one or more other recommendation algorithms not specifically described in detail herein, such as more traditional content-based filtering and collaborative filtering algorithms.

The recommender system database 120 may store the item preference data 122 and the item property value data 124 mentioned above, as well as any other temporary and/or permanent data generated or employed in the various embodiments discussed herein. The recommender system database 120 may be a relational database system or any other type of database or general data storage system that may allow the various modules 102-116 to retrieve, update, and/or store any of the data or information mentioned herein.

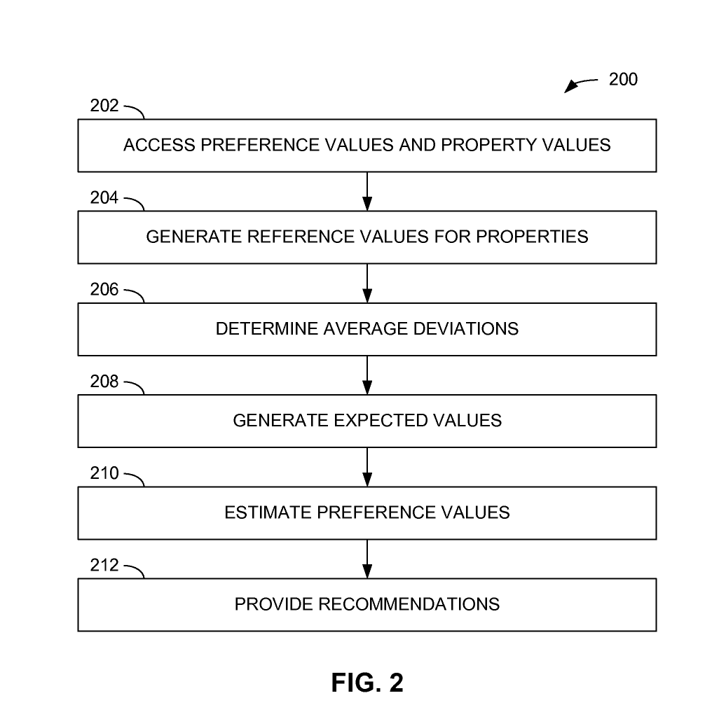

FIG. 2 is a flow diagram illustrating an example method 200 of recommending one or more items to one or more target users. In one example, the recommender system 100 of FIG. 1 and, more specifically, the various modules 102-116 incorporated therein, may perform the method 200, although other devices or systems not specifically described herein may perform the method 200 in other implementations.

In the method 200, preference values for a plurality of items, as specified by or on behalf of each of a plurality of users, are accessed (operation 202). Each of these preference values may indicate a particular level of preference or satisfaction by a user regarding a particular item known to that user. Also, in some examples, the items are of a particular item type (e.g., wine, movies, restaurants, music, etc.). Property values for multiple properties of the plurality of items, as specified by or on behalf of the plurality of users, may also be accessed (also operation 202). In some embodiments, a person or entity other than the users may specify each of the particular properties (e.g., sweetness, clarity, etc.) associated with a particular item type (e.g., wine), as well as a range of acceptable values from which the user may select a particular property value that represents the property value for that property as perceived by the user. In addition, the person or entity may also specify the specific value range (e.g., a value from one to ten) from which the user is to select preferences values for each known item of the item type.

Reference property values for each of the properties of the items may then be generated based on the accessed property values (operation 204). In some examples, the reference property value for a particular property of a specific item may be viewed as an average of the accessed property values from a plurality of users for that property of the item. In some embodiments, the particular calculation or selection of the reference property values (e.g., mean, median, mode, and the like) may be based on the type of distribution (e.g., a normal or Gaussian distribution, a non-normal distribution, a unimodal distribution, a bimodal distribution, a multimodal distribution, or a skewed distribution) exhibited by the accessed property values.

Average property value deviations by a target user from the reference property values for each property of items known to the target user may then be determined (operation 206). In some examples, both the magnitude and the direction or sign of the deviation (e.g., positive deviations greater than the reference property value and negative deviations less than the reference property value) may be employed to determine an average positive deviation and a separate average negative deviation of a property value set by the target user for known items compared to other users.

The reference property values and the average deviations for the properties of the items known to the target user may then be used to generate expected property values associated with the target user for items that are unknown to the target user (operation 208). In one example, the average positive and negative deviations by the target user for a particular property are added to and subtracted from, respectively, the reference property value for that property to yield an expected property value by the target user for that property.

Preference values by the target user for unknown items may then be estimated using the expected property values that were generated (operation 210). In some embodiments, one or more items known to the target user are selected for each unknown item based on their similarity with that unknown item. The estimated preference value for the unknown item may then be based on the preference values for the selected known items.

The estimated preference values for the items unknown to the target user may then be employed to generate recommendations to the target user for one or more of the unknown items (operation 212). In some examples, a predetermined number or percentage of the unknown items having the highest estimated preference values may be recommended to the target user.

While FIG. 2 depicts the operations 202-212 of the method 200 as being executed serially in a particular order, other orders of execution, including parallel or concurrent execution of one or more of the operations 202-212, are possible. For example, while the method 200 is described above as being applied to a particular target user and a specific item type, the method 200 may be applied to many types of items types and different target users in parallel. In addition, some items may be classified as more than one item type, possibly indicating some level or degree of overlap in the information indicated above that is employed to provide recommendations within each of the different item types.

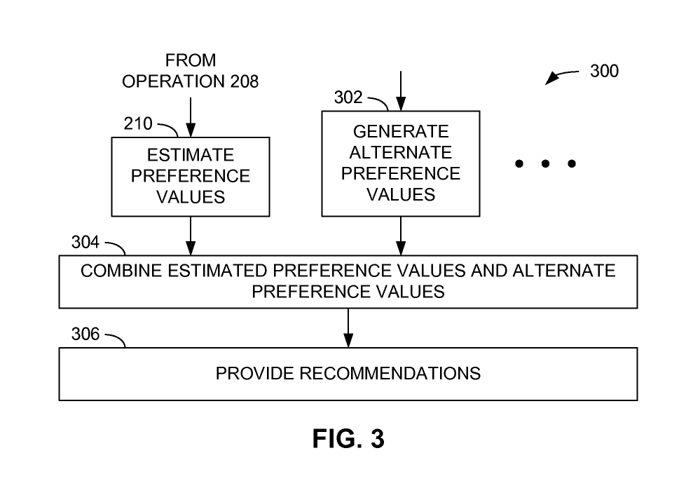

FIG. 3 is a flow diagram illustrating a second example method 300 of recommending an item. In the method 300, the estimated preference values provided in operation 210 of FIG. 2, along with one or more sets of alternate preference values that are generated according to another method or system (operation 302), may be combined to produce an overall or summary estimated preference associated with the target user for each of one or more unknown items (operation 304). These overall or summary estimated preferences may then be used to provide recommendations (operation 306), substantially as described above. In one example, each of the preference values from operations 210 and 302 may be combined by way of a linear combination of the values to yield a single, normalized preference value for an unknown item that may be compared against corresponding preference values for other items to provide the recommendation for one or more of the unknown items to the target user. Other methods of combining individual preference values to yield an overall preference value are also possible.

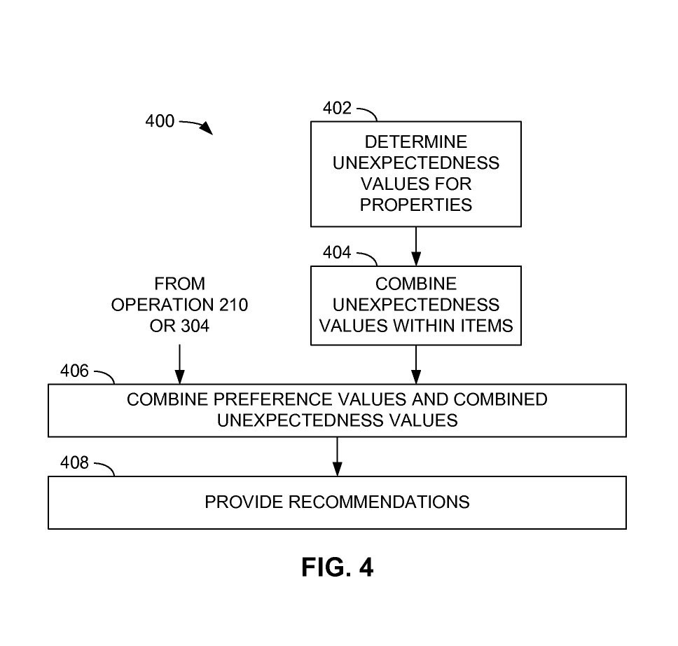

FIG. 4 is a flow diagram illustrating a third example method 400 of recommending an item. In the method 400, the estimated preference values provided by way of operation 210 of FIG. 2 or operation 304 of FIG. 3 may be utilized in conjunction with the unexpectedness values mentioned above to generate recommendations. More specifically, unexpectedness values for each property of each item unknown to the target user may be determined (operation 402). Within each unknown item, the unexpectedness values for each property may be combined to provide a single overall unexpectedness value for each unknown item (operation 404). Each of these overall unexpectedness values may then be combined with the preference values produced by operation 210 or operation 304 to provide an overall adjusted preference or desirability value associated with each of the unknown items (operation 406), which may then be employed, in turn, to provide recommendations for one or more of the unknown items to the target user (operation 408).

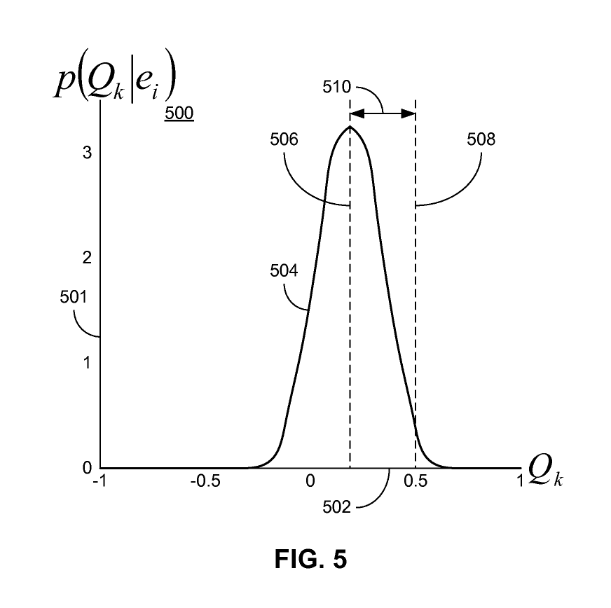

As described above in connection with the generation of the reference property values (operation 204 of FIG. 2) and the determination of the average property value deviations (operation 206 of FIG. 2), FIG. 5 is a graph 500 of an example probability distribution 504 of property values for an item as specified by a plurality of users. More specifically, the graph 500 shows an idealized probability distribution p(Qₖ|eᵢ) (shown along a vertical axis 501) of property values for a particular k^{th} property Qₖ of an i^{th} item eᵢ known by the users, including the target user. The range of possible values for the property Qₖ is −1 to +1 (shown along a horizontal axis 502). In this example, the distribution 504 approximates a normal distribution with a mean value 506 that serves as the reference property value (or expected property value) E[Qₖ|eᵢ]. Also shown in FIG. 5 is a property value 508 for the target user o for the k^{th} property of the known item eᵢ, designated herein as q_{k,e}_{ᵢ}_{,o}. The difference between the reference property value (mean value 506, or E[Qₖ|eᵢ]) and the property value 508 associated with the target user (q_{k,e}_{ᵢ}_{,o}) is the deviation 510 for that particular property Qₖ, termed δ_{Q}_{ₖ}_{,e}_{ᵢ}_{,o}:

δ_{Q}_{ₖ}_{,e}_{ᵢ}_{,o}=q_{k,e}_{ᵢ}_{,o}−E[Qₖ|eᵢ]

In the example of FIG. 5, the deviation δ_{Q}_{ₖ}_{,e}_{ᵢ}_{,o} is positive since the property value q_{k,e}_{ᵢ}_{,o} associated with the target user o is greater than the reference property value E[Qₖ|eᵢ]. Conversely, a negative deviation value results from the property value q_{k,e}_{ᵢ}_{,o} associated with the target user o being less than the reference property value E[Qₖ|eᵢ]. In one example, the positive and negative deviations are assigned to separate variables Δ_{Q}_{ₖ}⁺ and Δ_{Q}_{ₖ}⁻, respectively. These samples for the same property Qₖ, in turn, collected over all items eᵢ,e₁₊₁, . . . known to the target user o (or some subset thereof, especially if the items known to the target user o are numerous) may be employed as samples for separate positive and negative probability distributions, p(Δ_{Q}_{ₖ}⁺|o,eᵢ,eᵢ₊₁, . . . ) and p(Δ_{Q}_{ₖ}⁻|o,eᵢ,eᵢ₊₁, . . . ). The expected values of these distributions, namely E[Δ_{Q}_{ₖ}⁺|o,eᵢ,eᵢ₊₁, . . . ] and E[Δ_{Q}_{ₖ}⁻|o,eᵢ,eᵢ₊₁, . . . ], (e.g., an average value for a normal distribution) provide an indication of the deviations in the perception of the target user o for this particular property Qₖ across the items known to the target user.

To estimate how the target user would perceive the same property Qₖ in an unknown item, the average or expected values E[Δ_{Q}_{ₖ}⁺|o,eᵢ,eᵢ₊₁, . . . ] and E[Δ_{Q}_{ₖ}⁻|o,eᵢ,eᵢ₊₁, . . . ] for the deviations may be added to the reference property value E[Qₖ|eⱼ] for the same property Qₖ of an unknown item eⱼ, resulting in an expected or estimated property value \hat{q}_{k,e}_{ⱼ}_{,o} for the property Qₖ of that unknown item eⱼ:

\hat{q}_{k,e}_{ⱼ}_{,o}=(E[Δ_{Q}_{ₖ}⁺|o,eᵢ,eᵢ₊₁, . . . ]+E[Δ_{Q}_{ₖ}⁻|o,eᵢ,eᵢ₊₁, . . . ])+E[Qₖ|eⱼ]

Presuming the calculation of the estimated property value \hat{q}_{k,e}_{ⱼ}_{,o} was performed for each property Qₖ of each item eⱼ that is unknown to the target user o, each unknown item eⱼ may be represented or characterized by its estimated property values \hat{q}_{k,e}_{ⱼ}_{,o}. Similarly, each of the known items eᵢ may be represented by its accessed property values q_{k,e}_{ⱼ}_{,o}, mentioned above. In one example, each of the known items eᵢ and unknown items eⱼ may be represented as a multidimensional property vector, with each dimension of each vector being represented with a corresponding estimated or accessed property value for that item. Presuming all dimensions or properties are weighted equally, a Euclidean distance d(eᵢ,e₁)^{q} between a vector qₑ_{ᵢ}_{,o} for a known item eᵢ and a vector \hat{q}ₑ_{ⱼ}_{,o} for an unknown item eⱼ may be determined using the norm of the difference between the vectors, in which |Q| is the number of properties:

d(eᵢ,eⱼ)^{q}=∥qₑ_{ᵢ}_{,o}−\hat{q}ₑ_{ⱼ}_{,o}∥=\sqrt{Σₖ₌₁^{|Q|}(q_{k,e}_{ⱼ}_{,o}−\hat{q}_{k,e}_{ⱼ}_{,o})²}

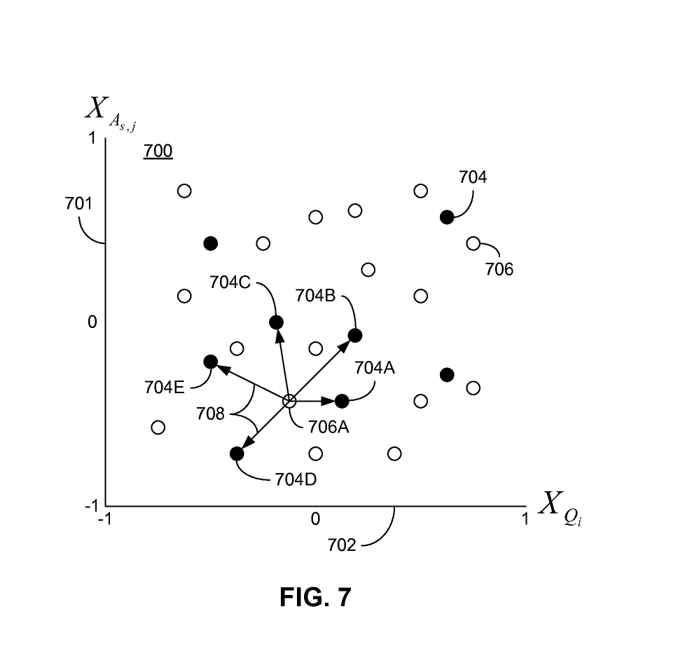

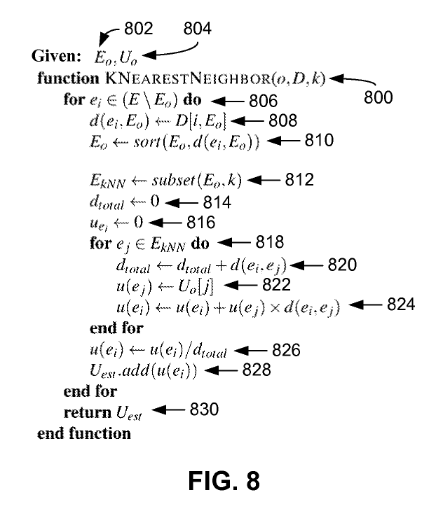

These distances d(eᵢ,eⱼ)^{q} may be employed in any of a number of ways in order to estimate a target user preference value for each of the unknown items eⱼ. In one embodiment, a k-nearest-neighbor (kNN) algorithm may be employed to select one or more known items eᵢ for estimation of a target user preference value for a particular unknown item eⱼ. An example kNN algorithm employed for such a purpose is discussed below in conjunction with FIGS. 7 and 8. In other examples, other distance metrics, including those that are non-Euclidean in nature, as well as other algorithms for employing those metrics to estimate or predict a target user preference value, may be utilized.

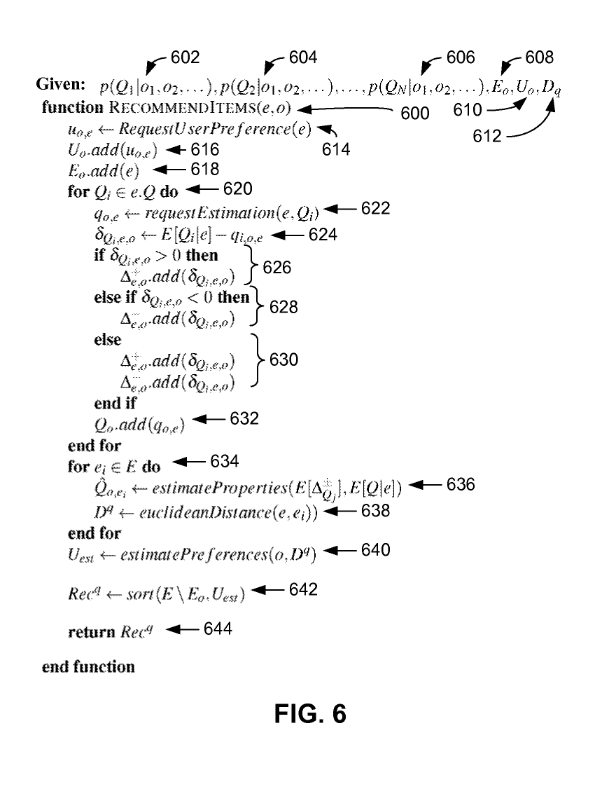

FIG. 6 is a pseudocode listing for an example function 600 (“RecommendItems”) that may recommend, to a target user o, items that are unknown to the target user. Input parameters to the function include the target user o and a particular item e known to the target user. Also available to the function 600 are the probability distributions 602, 604, 606 for each property Q₁, Q₂, . . . , Q_{N}, respectively, and for each user o₁, o₂, . . . (respectively, p(Q₁|o₁, o₂, . . . ), p(Q₂|o₁, o₂, . . . ), and p(Q_{N}|o₁, o₂, . . . )). Also provided are a list 608 of all items known to the target user o (Eₒ), a list 610 of preference values provided by or for the target user o for each of those items (Uₒ), and a list 612 of distances associated with the target user between each unknown item and a known item (D_{q} or D^{q}).

The function 600 is configured to be called each time the target user o provides a preference value and associated property values for the item e in question. More specifically, in the function 600, a call to another function (“requestUserPreference”) using an input parameter representing the item e returns the target user's preference value, which is assigned to u_{o,e} (operation 614). In addition, that value is added to the preference value list Uₒ (operation 616), and an indicator for the item e is added to the known item list Eₒ (operation 618).

For each property Qᵢ associated with the item e (operation 620), the function 600 calls another function (“requestEstimation”) to access the property value specified by or on behalf of the target user for that property of the item e and stores the returning value in q_{o,e} (operation 622). The function 600 then calculates the deviation δ_{Q}_{ᵢ}_{,e,o} between the specified property value q_{o,e} and the reference property value E[Qᵢ|e] for that property (operation 624). If the deviation δ_{Q}_{ᵢ}_{,e,o} is positive, the deviation is added as a sample to a list Δ_{e,o}⁺ of positive deviations of the property value for the target user o associated with item (operation 626). Oppositely, if the deviation δ_{Q}_{ᵢ}_{,e,o} is negative, the deviation is added as a sample to a list Δ_{e,o}⁻ of negative deviations of the property value for the target user o associated with item (operation 628). Otherwise, the sample is zero, which is added to both lists Δ_{e,o}⁺ and Δ_{e,o}⁻ (operation 630). Also, the specified property value q_{o,e} may be added to a list Qₒ of property values specified by or on behalf of the target user o (operation 632).

After each specified property value is processed as described above in operations 620-632, then for each item eᵢ that is unknown to the target user o (operation 634), a function (“estimateProperties”) is called using expected or average values of the deviations of the property values by the target user, as well as the reference property values, for each of the properties of the unknown item to produce estimated property values \hat{Q}_{o,e}_{ᵢ} for the properties of the unknown item (operation 636). A function (“euclideanDistance”) may then be called to employ the newly estimated property values for the unknown item eᵢ to determine Euclidean distances D^{q} between the unknown item eᵢ and each of the known items e (operation 638). In one example, the “euclideanDistance” function may provide distance information that may be employed by a kNN algorithm. In other embodiments, other types of algorithms, or distances other than Euclidean distances, may be used. A call to a preference estimation function (“estimatePreferences”) may then be performed to generate a list hₑₛₜ of estimated preferences for items unknown to the target user o based on the Euclidean distances D^{q} (operation 640). The list Uₑₛₜ of estimated preferences, along with a list E\Eₒ of items that are unknown to the target user o, may then be sorted via another function call to generate a list Rec^{q} of recommended unknown items according to a descending order of their estimated preference values (operation 642). This recommended item list Rec^{q} may then be returned to the caller of the function 600 for presentation to the target user o (operation 644).

Consequently, in the example of FIG. 6, the calculation of the estimated property values for unknown items, the generation of distances between the unknown items and known items, the estimation of preference values for the unknown items, and the recommending of one or more of the unknown items based of the estimated preference values, occurs each time a preference value and associated property values for an item previously unknown to the target user o is provide by or on behalf of the target user. In other examples, these calculations may occur after the preference and property values are received for more than one product, such as some predetermined number of products.

FIG. 7 is a graph 700 of an example distribution of items, both known and unknown to a target user, according to stated and estimated property values of the target user. In the graph 700, each empty circle represents a vector for an unknown item 706 from the perspective of the target user according to estimated property values, as described above. Each filled circle represents a vector for a known item 704 of the target user, as represented by property values specified by or on behalf of that target user. While in many embodiments more than two properties are associated with each item, resulting in vectors with dimensions greater than two, a two-dimensional graph (shown in FIG. 6 with dependent axis 701 (X_{Qi}) representing a first property and independent axis 702 (X_{A}_{_{s,j}}) representing a second property) that displays the distances between items exhibiting only two properties in a two-dimensional metric space, is employed for simplicity. In the graph 700, distances 708 between an unknown item 706A and the five nearest known items 704A through 704E are depicted as an example of a kNN algorithm being employed, wherein k=5. Thus, the kNN algorithm identifies the five known items 704A through 704E that are most similar to the unknown item 706A according to estimated and specified property values associated therewith. Those distances 708 may then be employed to estimate preference values for the target user for the unknown item 706A based on the stated preference values for the known items 704A through 704E. In one example, each of the properties associated with a specific dimension are weighted equally toward the overall distance values. However, unequal weighting of dimensions may be employed in other embodiments.

In one example of the kNN algorithm, the contribution of the preference value of each of a set Eₒ of items known to a target user o to the preference value of an unknown item eᵢ may be weighted based on the distance d(eᵢ, e) between the unknown item eᵢ and the known items eεEₒ, as illustrated in FIG. 7, to yield a preference value U_{o,e}_{ᵢ}:

$${U}_{o , {e}_{i}} = \frac{{Σ}_{e ∈ {E}_{o}} ( d ( {e}_{i} , e ) \times {U}_{o , e} )}{{Σ}_{e ∈ {E}_{o}} d ( {e}_{i} , e )}$$

FIG. 8 is a pseudocode listing for an example function 800 that may determine the most similar known items for each item that is unknown to a target user o and return estimated preferences associated with the target user for the unknown items according to a kNN algorithm. As mentioned above, while the specific example of a kNN algorithm is described herein, other content-based preference prediction algorithms may be utilized in other embodiments. The function 800 is provided input that specifies the target user o, a list D of metric distances representing similarity scores between various items, and a parameter k indicating the number of nearest neighbors that are to be determined by the kNN algorithm. Also provided in this example are a list 802 (Eₒ) of items known to the target user o and a list 804 (Uₒ) of preferences specified by or on behalf of the target user o.

In the function 800, for each item eᵢ of the items E\Eₒ that are unknown to the target user o (operation 806), a distance between the current unknown item eᵢ and each of the known items Eₒ may be assigned to d(eᵢ,Eₒ) (operation 808). As indicated earlier, this distance is based on previously-specified property values for the items. The known items Eₒ may then be sorted in ascending order according to distance from the unknown item eᵢ (operation 810), with the first k members of the list of known items Eₒ being assigned to a list E_{kNN} of k nearest known items (operation 812). Variables indicating a summed (total) distance dₜₒₜₐₗ and the estimated preference value uₑ_{ᵢ} (or, alternatively, u(eᵢ)) of the current unknown item eᵢ may be reset (operations 814 and 816). Then, for each known item eⱼ of the list E_{kNN} of k nearest known items (operation 818), the distance d(eᵢ,eⱼ) between the current unknown item eᵢ and the current known item eⱼ is added to the total distance dₜₒₜₐₗ (operation 820), the preference value Uₒ [j] for the current known item eⱼ is assigned to u(eⱼ) (operation 822), and the preference value u(eⱼ) is weighted by the distance d(eᵢ,eⱼ) between the current unknown item eᵢ and the current known item eⱼ and added to the estimated preference value u(eᵢ) of the current unknown item eᵢ (operation 824). For example, a strongly-preferred known item eⱼ that is located close to the unknown item eᵢ may be weighted more heavily than a more distant, but less preferred, known item eⱼ, thus possibly resulting in a prediction that the target user will likely prefer the unknown item eᵢ. After the preference values u(eⱼ) for each of the k nearest known items E_{kNN} is weighted by the corresponding distance d(eᵢ,eⱼ) between the current unknown item eᵢ and the current known item eⱼ and added to the estimated preference value u(eᵢ) of the current unknown item eᵢ, the resulting estimated preference value u(e₁) is divided by the total distance dₜₒₜₐₗ to produce the final estimated preference value u(eᵢ) (operation 826), which is then added to a list Uₑₛₜ of estimated preference values for each of the unknown items eᵢ (operation 828). After all of the unknown items eᵢ are processed in a similar manner, the complete list Uₑₛₜ of estimated preference values for each of the unknown items eᵢ may be returned to the calling function (operation 830), which, in one example, is the function 600 of FIG. 6. In that instance, the call to the “estimatePreferences” function (operation 640) results in a call to function 800 of FIG. 8.

As discussed above, in some embodiments, the list Uₑₛₜ of estimated preference values for each of the unknown items eᵢ may be combined with other preference values generated using other methods, such as by collaborative filtering and/or content-based filtering. For example, one other alternative method that yields a preference value Uₑ_{ᵢ}_{,o}^{s} for a particular unknown item eᵢ and target user o may be combined with an estimated preference Uₑ_{ᵢ}_{,o}^{q}, as described above, using a weighting parameter αε[0,1] to form a linear combination of the preference values to generate an overall preference value Uₑ_{ᵢ}_{,o}:

Uₑ_{ᵢ}_{,o}=α×Uₑ_{ᵢ}_{,o}^{q}+(1−α)×Uₑ_{ᵢ}_{,o}^{s}

In examples involving more than two preference values, additional weighting parameters beyond α (e.g., α and β for three preference values, α, β, and γ for four preference values, and so on) may be employed to combine the preference values to produce or predict the overall preference value Uₑ_{ᵢ}_{,o}.

Combining at least two of these preference values for each unknown item eᵢ, in at least some embodiments, may help provide worthwhile recommendations in situations in which a significant amount of preference and property value information is yet to be collected or accessed. In some examples, the influence of the two or more types of preference values may be altered by changing the value of a over time, such as, for example, increasing its value so that the use of user-supplied property values, as discussed herein, becomes more important as more of that data is accessed or received.

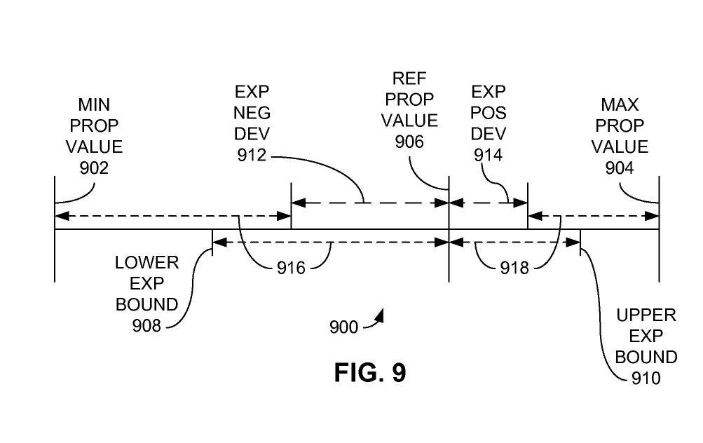

In addition or in the alternative, the list Uₑₛₜ may be supplemented with unexpectedness values associated with each of the unknown items eᵢ. To that end, FIG. 9 is a graphical representation of a range of possible property values for a particular property that indicates the lower and upper expectedness boundaries that may be employed to generate the unexpectedness values, as discussed earlier.

In FIG. 9, a range 900 of possible property values for a particular property Qⱼ of items e of a particular type extending from a minimum possible property value 902 (e.g., q_{j,min}) to a maximum possible property value 904 (e.g., q_{j,max}), is illustrated, along with a reference property value 906 (e.g., E[Qⱼ|eᵢ]) for a particular unknown item eᵢ. Also depicted is an expected negative deviation 912 (e.g., E[Δ_{Q}_{ⱼ}⁻|o,eᵢ,eᵢ₊₁, . . . ]) and an expected positive deviation 914 (e.g., E[Δ_{Q}_{ⱼ}⁺|o,eᵢ,eᵢ₊₁, . . . ]) of the property value for items e specified by or on behalf of a target user o, as described above. In one example, a lower expectedness boundary 908 (e.g., τ_{Q}_{ⱼ}_{,o}⁻) may be determined that is lower than the reference property value 906 by the amount of a difference 916 between the reference property value 906, less the expected negative deviation 912, and the minimum property value 902. Similarly, an upper expectedness boundary 910 e.g., τ_{Q}_{ⱼ}_{,o}⁺) may be determined that is higher than the reference property value 906 by the amount of a difference 918 between the reference property value 906, plus the expected positive deviation 914, and the maximum property value 904. Mathematically:

$$Lower expectedness boundary {τ}_{{Q}_{j} , o}^{-} = E [ {Q}_{j} \vert {e}_{i} ] - ( E [ {Q}_{j} \vert {e}_{i} ] - E [ {Δ}_{{Q}_{j}}^{-} \vert o , {e}_{i} , {e}_{i + 1} , … ] - {q}_{j , min} ) = E [ {Δ}_{{Q}_{j}}^{-} \vert o , {e}_{i} , {e}_{i + 1} , … ] + {q}_{j , min}$$

$$Upper expectedness boundary {τ}_{{Q}_{j} , o}^{+} = E [ {Q}_{j} \vert {e}_{i} ] + ( {q}_{j , max} - E [ {Q}_{j} \vert {e}_{i} ] - E [ {Δ}_{{Q}_{j}}^{+} \vert o , {e}_{i} , {e}_{i + 1} , … ] ) = {q}_{j , max} - E [ {Δ}_{{Q}_{j}}^{+} \vert o , {e}_{i} , {e}_{i + 1} , … ]$$

Accordingly, in this example, the lower expectedness boundary 908 (e.g., τ_{Q}_{ⱼ}_{,o}⁻) and the upper expectedness boundary 910 (e.g., τ_{Q}_{ⱼ}_{,o}⁺) may be independent of the reference property value E[Qⱼ|eᵢ] for a particular unknown item eᵢ.

Using these expectedness boundaries for a particular property Qⱼ, an unexpectedness value for property Qⱼ of unknown item eᵢ may be determined. In an example, a non-zero unexpectedness value is provided if the estimated property value \hat{q}_{j,e}_{ᵢ}_{,o} for property Qⱼ of unknown item eᵢ resides between the minimum property value 902 and the lower expectedness boundary 908, or between the upper expectedness boundary 910 and the maximum property value 904. Further, an estimated property value \hat{q}_{j,e}_{ᵢ}_{,o} associated with the target user, as described above, equal to one of the boundaries 908, 910 may result in a zero unexpectedness value, while an estimated property value \hat{q}_{j,e}_{ᵢ}_{,o} equal to one of the minimum property value 902 or the maximum property value 904 may result in an unexpectedness value of one. In one example, if a linear gradient for the unexpectedness value is presumed between each expectedness boundary 908, 910 and its associated minimum property value 902 or maximum property value 904, a unexpectedness value Ψ_{Q}_{ⱼ}_{,e}_{ᵢ}_{,o} for property Qⱼ may be determined mathematically:

$${Ψ}_{{Q}_{j} , {e}_{i} , o} = \{ \begin{matrix}1 - \frac{{q}_{j , max} - {\hat{q}}_{j , {e}_{i} , o}}{{q}_{j , max} - {τ}_{{Q}_{j} , o}^{+}} & if {\hat{q}}_{j , {e}_{i} , o} \geq {τ}_{{Q}_{j} , o}^{+} \\ 0 & if {τ}_{{Q}_{j} , o}^{-} < {\hat{q}}_{j , {e}_{i} , o} < {τ}_{{Q}_{j} , o}^{+} \\ 1 - \frac{{\hat{q}}_{j , {e}_{i} , o} - {q}_{j , min}}{{τ}_{{Q}_{j} , o}^{-} - {q}_{j , min}} & if {\hat{q}}_{j , {e}_{i} , o} \leq {τ}_{{Q}_{j} , o}^{-}\end{matrix}$$

After calculating the unexpectedness value Ψ_{Q}_{ⱼ}_{,e}_{ᵢ}_{,o} for each property Qⱼ, a total unexpectedness value Ψₑ_{ᵢ}_{,o} for the unknown item eᵢ may be determined by combining the individual unexpectedness values for each property, such as by averaging using the total number of properties |Q|:

$${Ψ}_{{e}_{i} , o} = \frac{{\sum }_{j = 1}^{\vert Q \vert} {Ψ}_{{Q}_{j} , {e}_{i} , o}}{\vert Q \vert}$$

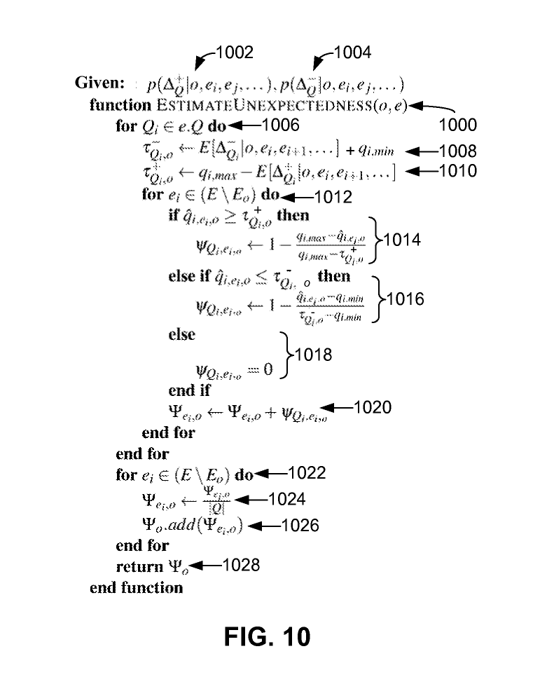

FIG. 10 is a pseudocode listing for an example function 1000 (“EstimateUnexpectedness”) that may estimate unexpectedness values. The function 1000 may be provided input that specifies the target user o and items e. Also provided to the function 1000 may be a distribution of positive deviations 1002 (p(Δ_{Q}⁺|o,eᵢ,eⱼ, . . . )) and negative deviations 1004 (p(Δ_{Q}⁻|o,eᵢ,eⱼ, . . . )) of property values for all properties Q for the target user o over known items eᵢ, eⱼ, . . . .

In the function 1000, for each property Qᵢ of the items e (operation 1006), the lower expectedness boundary τ_{Q}_{ᵢ}_{,o}⁻ (operation 1008) and the upper expectedness boundary τ_{Q}_{ᵢ}_{,o}⁺ (operation 1010) may be calculated, as described above in conjunction with FIG. 9. Then, for each item eᵢε(E\Eₒ) that is unknown to the target user o (operation 1012), the unexpectedness value Ψ_{Q}_{ᵢ}_{,e}_{ᵢ}_{,o} for the current property Qᵢ of item eᵢ is calculated as indicated above (operations 1014 through 1018) and then added to the summed (total) unexpectedness value Ψₑ_{ᵢ}_{,o} for current item eᵢ (operation 1020).

After the unexpectedness value Ψ_{Q}_{ᵢ}_{,e}_{ᵢ}_{,o} for each of the properties Qᵢ of each of the unknown items eᵢ is calculated, and the summed (total) unexpectedness value Ψₑ_{ᵢ}_{,o} for each of the unknown items eᵢ is generated, then for each of the unknown items eᵢ (operation 1022), the summed (total) unexpectedness value Tₑ_{ᵢ}_{,o} is divided by the number of properties |Q| to yield the final total (average) unexpectedness value Ψₑ_{ᵢ}_{,o} (operation 1024), which is then added to a list Ψₒ of unexpectedness values for the items unknown to the target user o (operation 1026). The list Ψₒ may be returned from the function 1000 (operation 1028) for use in providing a recommendation to the target user o.

As indicated above, an estimated preference Uₑ_{ᵢ}_{,o} for an unknown item eᵢ from the perspective of a target user o may be supplemented with a corresponding unexpectedness value Ψₑ_{ᵢ}_{,o} associated with the unknown item eᵢ. For example, the estimated preference Uₑ_{ᵢ}_{,o} may be combined with the corresponding unexpectedness value Ψₑ_{ᵢ}_{,o} using a parameter βε[0,1] to form a linear combination of these two values to generate an overall preference value Pₑ_{ᵢ}_{,o}:

Pₑ_{ᵢ}_{,o}=β×Ψₑ_{ᵢ}_{,o}+(1−β)×Uₑ_{ᵢ}_{,o}

In at least some of the embodiments described above, recommendations for many types of items may be provided to users by employing information indicating preferences and perceived property values provided by or on behalf of those users. The use of such information may not only lead to more effective or successful recommendations for the user, but also may alleviate the provider of the recommender system of providing extensive and explicit descriptions of the items, as much of the information is subjective in nature and is thus provided by the users themselves. Also, the use of unexpectedness values may further enhance user recommendations by potentially influencing the user to try new items that may not otherwise be recommended to the user by other systems, but ultimately may still be preferred by the user.

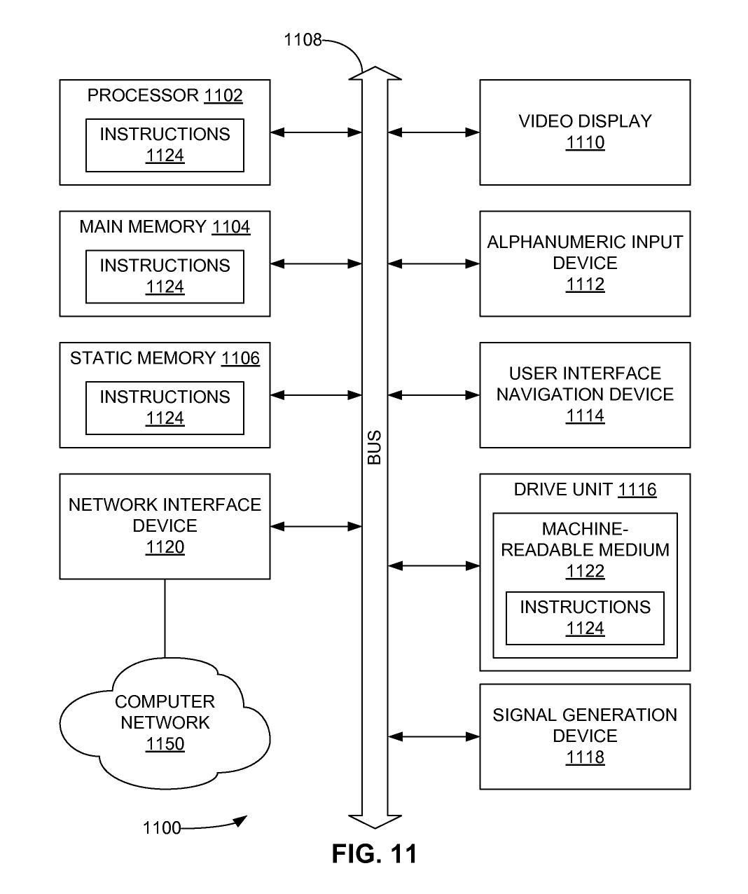

FIG. 11 depicts a block diagram of a machine in the example form of a processing system 1100 within which may be executed a set of instructions 1124 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions 1124 (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 1100 includes a processor 1102 (e.g., a central processing unit (CPU), a graphics processing unit (GPU), or both), a main memory 1104 (e.g., random access memory), and static memory 1106 (e.g., static random-access memory), which communicate with each other via bus 1108. The processing system 1100 may further include video display unit 1110 (e.g., a plasma display, a liquid crystal display (LCD), or a cathode ray tube (CRT)). The processing system 1100 also includes an alphanumeric input device 1112 (e.g., a keyboard), a user interface (UI) navigation device 1114 (e.g., a mouse), a disk drive unit 1116, a signal generation device 1118 (e.g., a speaker), and a network interface device 1120.

The disk drive unit 1116 (a type of non-volatile memory storage) includes a machine-readable medium 1122 on which is stored one or more sets of data structures and instructions 1124 (e.g., software) embodying or utilized by any one or more of the methodologies or functions described herein. The data structures and instructions 1124 may also reside, completely or at least partially, within the main memory 1104, the static memory 1106, and/or within the processor 1102 during execution thereof by processing system 1100, with the main memory 1104, the static memory 1106, and the processor 1102 also constituting machine-readable, tangible media.

The data structures and instructions 1124 may further be transmitted or received over a computer network 1150 via network interface device 1120 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 1100) or one or more hardware modules of a computer system (e.g., a processor 1102 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 1102 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 1102 that is configured using software, the general-purpose processor 1102 may be configured as respective different hardware modules at different times. Software may accordingly configure the processor 1102, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses that connect the modules). In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 1102 that are temporarily configured (e.g., by software) or permanently configured to perform the relevant operations. Whether temporarily or permanently configured, such processors 1102 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 1102 or processor-implemented modules. The performance of certain of the operations may be distributed among the one or more processors 1102, not only residing within a single machine but deployed across a number of machines. In some example embodiments, the processors 1102 may be located in a single location (e.g., within a home environment, within an office environment, or as a server farm), while in other embodiments, the processors 1102 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method of recommending an item, the method comprising:
accessing preference values for a plurality of items by a plurality of users;
accessing property values for multiple properties of the plurality of items by the plurality of users;
generating reference property values for the multiple properties of the plurality of items based on the property values for the multiple properties;
determining average deviations from the reference property values for the multiple properties across a first group of the plurality of items by a target user;
generating expected property values for the multiple properties of a second group of the plurality of items by the target user based on the reference property values and the average deviations;
estimating, using at least one hardware processor of a machine, preference values of the target user for the second group of the plurality of items based on the expected property values; and
recommending at least one of the second group of the plurality of items to the target user based on the estimated preference values.

2. The method of claim 1, wherein:
the first group of the plurality of items comprises those of the plurality of items for which a preference value and property values by the target user have been specified; and
the second group of the plurality of items comprises those of the plurality of items for which a preference value and property values by the target user have not been specified.

3. The method of claim 1, wherein each of the plurality of items comprises a product or a service available for purchase by the plurality of users.

4. The method of claim 1, further comprising:
generating the preference values based on purchases of the items by the plurality of users.

5. The method of claim 1, further comprising:
generating the property values for the multiple properties based on information from the plurality of users regarding the multiple properties of the plurality of items.

6. The method of claim 1, wherein the generating of the reference property values comprises:
determining a type of distribution of the property values for a first property of one of the plurality of items, wherein the generating of the reference property value for the first property of the one of the plurality of items is based on the type of distribution.

7. The method of claim 6, wherein the type of distribution comprises a normal distribution, and wherein the reference property value comprises a mean of the property values for the first property of the one of the plurality of items.

8. The method of claim 1, wherein the generating of the expected property values comprises adding each of the average deviations to a corresponding one of the reference property values.

9. The method of claim 1, wherein the estimating of the preference values of the target user for the second group of the plurality of items comprises:
generating a vector representing each of the first group of the plurality of items based on the property values for the multiple properties by the target user;
generating a vector representing each of the second group of the plurality of items based on the expected property values for the multiple properties by the target user;
selecting, for each one of the second group of the plurality of items, at least one of the first group of the plurality of items based on a distance between the vector representing the one of the second group of the plurality of items and the vectors representing each one of the first group of the plurality of items; and
determining the estimated preference value of the target user for each one of the second group of the plurality of items based on the preference values of the target user for each of the selected at least one of the first group of the plurality of items and the distance between the one of the second group of the plurality of items and each of the selected at least one of the first group of the plurality of items.

10. The method of claim 9, wherein the selecting of the at least one of the first group of the plurality of items comprises selecting a predetermined number of the vectors representing each of the first group of the plurality of items closest to the vector representing the one of the second group of the plurality of items.

11. The method of claim 9, wherein the determining of the preference value of the target user for each one of the second group of the plurality of items comprises weighting each preference value of the target user for each of the selected at least one of the first group of the plurality of items by the distance between the one of the second group of the plurality of items and each of the selected at least one of the first group of the plurality of items.

12. The method of claim 1, wherein:
the preference values of the target user comprise first preference values of the target user; and
the method further comprises linearly combining the first preference values of the target user with second preference values of the target user, wherein the recommending of the at least one of the second group of the plurality of items to the target user is based on the combination of the first preference values and the second preference values.

13. The method of claim 1, further comprising:
generating expectedness boundaries for the multiple properties of the second group of the plurality of items based on the average deviations; and
determining unexpectedness values for the multiple properties of the second group of the plurality of items based on the expectedness boundaries and the expected property values;
wherein the recommending of the at least one of the second group of the plurality of items is further based on the unexpectedness values.

14. The method of claim 13, wherein the determining of the unexpectedness values is based on a linear gradient between each of the expectedness boundaries and a corresponding limit of the property values of a corresponding property.

15. The method of claim 13, further comprising:
combining, for each of the second group of the plurality of items, the unexpectedness values for the multiple properties to generate a combined unexpectedness value for each of the second group of the plurality of items;
wherein the recommending of the at least one of the second group of the plurality of items is further based on the combined unexpectedness values.

16. The method of claim 15, further comprising linearly combining the preference values of the target user with the combined unexpectedness values, wherein the recommending of the at least one of the second group of the plurality of items to the target user is based on the combination of the preference values and the combined unexpectedness values.

17. A non-transitory computer-readable storage medium comprising instructions that, when executed by at least one processor of a machine, cause the machine to perform operations comprising:
accessing, for each of a plurality of items, one or more preference values, wherein each of the one or more preference values for an item is specified by one of a plurality of users, wherein each of the plurality of items comprises multiple properties;
accessing, for each of the properties of each of the plurality of items, one or more property values, wherein each of the one or more property values for a property of an item is specified by one of the plurality of users;
generating, for each of the properties of each of the plurality of items, a reference property value based on the one or more property values for the property of the item;
determining, for each of the properties of each of a first group of the plurality of items, an average deviation of a property value specified by a target user of the plurality of users from the reference property value for the property of the item;
generating, for each of the properties of each of a second group of the plurality of items, an expected property value by the target user based on the reference property value and the average deviation of the property value of the item, wherein the second group is distinct from the first group;
estimating, for each of the second group of the plurality of items, using at least one hardware processor of a machine, a preference value of the target user for the item based on the expected property value for each of the properties of the item, the property values specified by the target user for the properties of each of at least one of the first group of the plurality of items, and the preference value specified by the target user for each of the at least one of the first group of the plurality of items; and
recommending at least one of the second group of the plurality of items to the target user based on the estimated preference values.

18. The non-transitory computer-readable storage medium of claim 17, wherein the operations further comprise:
generating expectedness boundaries for each of the properties of each of the second group of the plurality of items based on the average deviations; and
determining unexpectedness values for each of the properties of each of the second group of the plurality of items based on the expectedness boundaries and the expected property values;
wherein the recommending of the at least one of the second group of the plurality of items is further based on the unexpectedness values.

19. A system comprising:
a data access module configured to access preference values for a plurality of items by a plurality of users and to access property values for multiple properties of the plurality of items by the plurality of users;
a reference property value generator configured to generate reference property values for the multiple properties of the plurality of items based on the property values for the multiple properties;
a deviation determination module configured to determine average deviations from the reference property values for the multiple properties across a first group of the plurality of items by a target user;
an expected property value generator configured to generate expected property values for the multiple properties of a second group of the plurality of items by the target user based on the reference property values and the average deviations;
a preference value estimator configured to estimate preference values of the target user for the second group of the plurality of items based on the expected property values; and
a recommendation module configured to recommend at least one of the second group of the plurality of items to the target user based on the estimated preference values.

20. The system of claim 19, further comprising:
an expectedness boundary generator configured to generate expectedness boundaries for the multiple properties of the second group of the plurality of items based on the average deviations; and
an unexpectedness value determination module configured to determine unexpectedness values for the multiple properties of the second group of the plurality of items based on the expectedness boundaries and the expected property values;
wherein the recommendation module is configured to recommend the at least one of the second group of the plurality of items further based on the unexpectedness values.
